(19) United States
(12) Patent Application Publication
(10) Pub. No.: US 2022/0359098 A1
(43) Pub. Date: Nov. 10, 2022

(54) LI ION CONDUCTOR AND METHOD FOR PRODUCING SAME

(71) Applicant: KANEKA CORPORATION, Osaka (JP)

(72) Inventors: Kazuaki Kanai, Osaka (JP); Ken Saito, Osaka (JP)

(73) Assignee: KANEKA CORPORATION, Osaka (JP)

(21) Appl. No.: 17/686,782

(22) Filed: Mar. 4, 2022

Related U.S. Application Data
(63) Continuation of application No. PCT/JP2020/033907, filed on Sep. 8, 2020.

(30) Foreign Application Priority Data
Sep. 13, 2019 (JP) 2019-167381

(51) Int. Cl. H01B 1/02; H01M 4/38; H01B 13/00

(52) U.S. Cl. CPC H01B 1/02; H01M 4/382; H01B 13/0016

(57) ABSTRACT

A Li ion conductor includes a garnet-type composite metal oxide phase (L) containing Li, La, Zr, and O. The Li ion conductor has a diffraction peak at least one of at 2θ=13.8° ±1° and at 2θ=15.2° ±1° in X-ray diffraction measurement using CuKa rays. The Li ion conductor may have a metal-containing phase (K) different from the garnet-type composite metal oxide phase (L), and the metal-containing phase (K) contains a halogen element and Li.

### TECHNICAL FIELD

One or more embodiments of the present invention relate to an Li ion conductor.

### BACKGROUND

Research and development of Li ion secondary batteries has been actively carried out for mobile devices, hybrid vehicles, electric vehicles, and household power storage applications. Li ion secondary batteries used in these fields are required to have high safety, long-term cycle stability, high energy density, and the like.

Among them, all-solid-state batteries using solid electrolytes are attracting attention because of their high safety. For example, a lithium ion conductor LIC of Patent Literature 1 is produced by first producing an ion conductor, and then mixing and heating a lithium halide and the ion conductor. For example, in the case of LLZ-MgSr powder obtained by performing substitution with Mg and Sr elements on an ion conductor Li₇La₃Zr₂O₁₂, raw materials (Li₂CO₃, MgO, La(OH)₃, SrCO₃, ZrO₂, SrCO₃, ZrO₂) including each element of LLZ-MgSr are mixed for 15 hours and calcined at 1000° C. for 10 hours, and then powder of a lithium halide (for example, LiI) is further mixed to obtain mixed powder, and the mixed powder is pressed together with a stainless current collector by a press machine to obtain a green compact, and the green compact is heat-treated at 80° C. for 17 hours.

### SUMMARY

One or more embodiments of the present invention provide an Li ion conductor that includes a garnet-type composite metal oxide phase, that exhibits good lithium ion conductivity, and that is different from that of Patent Literature 1, and provide a method for producing the same.

One or more embodiments of the present invention are as follows. [1] An Li ion conductor comprising a garnet-type composite metal oxide phase (L) containing Li, La, Zr, and O, wherein

the Li ion conductor has a diffraction peak at least one of at 2θ=13.8° ±1° and at 2θ=15.2° ±1° in X-ray diffraction measurement using CuKa rays. [2] The Li ion conductor according to [1], wherein the Li ion conductor has a metal-containing phase (K) different from the phase (L), and the phase (K) contains a halogen element and Li. [3] The Li ion conductor according [1] or [2], wherein a diffraction peak corresponding to 2θ=30.9° among diffraction peaks of a cubic crystal Li_{6.25}Ga_{0.25}La₃Zr₂O₁₂ in X-ray diffraction measurement using CuKa rays is observed at not less than 20 =30.5° and not greater than 30.9° . [4] The Li ion conductor according to any one of [1] to [3], wherein the Li ion conductor has a lattice constant of greater than 12.95 Å and not greater than 13.15 Å. [5] The Li ion conductor according to any one of [1] to [4], wherein the Li ion conductor has an activation energy Ea of 0.6 eV or less by impedance measurement. [6] The Li ion conductor according to any one of [1] to [5], wherein the Li ion conductor has an Li ion conductivity σₜₒₜₐₗ of 1.0×10⁻⁷ S/cm or greater at room temperature by impedance measurement. [7] A method for producing an Li ion conductor comprising a garnet-type composite metal oxide phase (L) containing Li, La, Zr, and 0, the method comprising

connecting interfaces of the garnet-type composite metal oxide phase (L) using a eutectic mixture having a melting point of 600° C. or lower. [8] The method according to [7], wherein the interfaces of the phase (L) are connected by molding a mixture of the eutectic mixture having a melting point of 600° C. or lower and a garnet-type composite metal oxide containing Li, La, Zr, and 0, and heat-treating an obtained molded product at 600° C. or lower. [9] The method according to [7] or [8], wherein the eutectic mixture is a eutectic mixture of two metal halides. [10]The method according to any one of [7] to [9], wherein the eutectic mixture is a eutectic mixture of LiF, ZrCl₄, AlCl₃, NbCl₅, or TaCl₅ with LiCl or a eutectic mixture of LiF with TaF₅.

According to the Li ion conductor of one or more embodiments of the present invention, it is possible to provide a good lithium ion conductor, and it is possible to use the lithium ion conductor as a component of an excellent solid electrolyte for a secondary battery.

### BRIEF DESCRIPTION OF THE DRAWINGS

FIG. 1 is an XRD diffraction chart in Example 1. FIGS. 2A and 2B show photographs as a substitute for a drawing, showing SEM observation images of the Example and a comparative example.

FIG. 3 is an enlarged view of the XRD diffraction chart in Example 1.

### DETAILED DESCRIPTION

In order to obtain an Li ion conductor that exhibits good lithium ion conductivity, the present inventors have conducted studies, and as a result, it has become clear that one or more embodiments of the present invention can be achieved by connecting the interfaces of a garnet-type composite metal oxide phase (L) using a eutectic mixture having a melting point of 600° C. or lower. More specifically, (1) a garnet-type composite metal oxide and the eutectic mixture having a melting point of 600° C. or lower may be mixed and heat- treated, or (2) a mechanochemical treatment may be performed on the raw materials of the garnet-type composite metal oxide and the eutectic mixture having a melting point of 600° C. or lower.

The eutectic mixture may be a eutectic mixture of two metal halides, for example, a eutectic mixture of LiF, ZrCl₄, AlCl₃, NbCl₅, or TaCl₅ with LiCl or a eutectic mixture of LiF with TaF₅, a eutectic mixture of LiF, ZrCl₄, AlCl₃, NbCl₅, or TaCl₅ with LiCl, a eutectic mixture of LiF, AlCl₃, NbCl₅, or TaCl₅ with LiCl, a eutectic mixture of AlCl₃, NbCl₅, or TaCl₅ with LiCl, or a eutectic mixture of LiCl with TaCl₅.

In the method (1) of mixing and heat-treating the garnet-type composite metal oxide and the eutectic mixture having a melting point of 600° C. or lower, preferably, the garnet-type composite metal oxide and the eutectic mixture having a melting point of 600° C. or lower are mixed, pressure is applied to the obtained mixture to obtain a molded body such as pellets, and the molded body is heat-treated. Examples of the heat treatment may include annealing the molded body at 600° C. or lower, 500° C. or lower, or 300° C. or lower, for 5 to 600 minutes, or 10 to 480 minutes. The lower limit of the annealing temperature is not particularly limited, and, for example, may be 150° C. or may be 200° C. In addition, the annealing temperature may be not lower than 150° C. (not lower than 200° C.) and not lower than the temperature 10° C. below a melting point of the eutectic mixture (not lower than the melting point). The annealing may be performed in an atmosphere of an inert gas such as nitrogen or Ar. The pressure at the time of producing the above-described molded body may be, for example, about 300 MPa to 450 MPa. The mixing of the garnet-type composite metal oxide and the eutectic mixture having a melting point of 600° C. or lower, the molding of the obtained mixture, and the annealing may be performed in an environment where the humidity is sufficiently reduced, such as a glove box or a dry room, and the dew point temperature may be, for example, —40° C. to —90° C. In the method (1), the ratio of the eutectic mixture with respect to 100 parts by mass of the garnet-type composite metal oxide can be set as appropriate according to the type of the eutectic mixture to be used, the pressure at the time of producing the molded body, the annealing conditions, and the like, and the amount of the eutectic mixture can be, for example, 15 to 60 parts by mass or 20 to 50 parts by mass.

The garnet-type composite metal oxide used in the method (1) may be obtained by mixing the raw materials of the composite metal oxide and calcining the mixture at 1000 to 1100° C. for about 6 to 12 hours, or may be obtained by performing a mechanochemical treatment on the raw materials of the composite metal oxide. The mechanochemical treatment can be performed by shearing a mixture including powders of the raw materials of the composite metal oxide while compressing the mixture under dry conditions.

The method (2) of performing a mechanochemical treatment on the raw materials of the garnet-type composite metal oxide and the eutectic mixture having a melting point of 600° C. or lower, can be carried out, for example, by shearing a mixture including the eutectic mixture having a melting point of 600° C. or lower and a mixture of powders of the raw materials of the composite metal oxide while compressing the mixture under dry conditions. After the mechanochemical treatment of the (2), the heat treatment described in the (1) may be further performed.

In both of the (1) and (2), the raw materials of the garnet-type composite metal oxide are Li source powder, La source powder, Zr source powder, and at least one of Al source powder and Ga source powder to be used as needed. As the Li source powder, the La source powder, the Zr source powder, the Al source powder, and the Ga source powder, for example, oxides, carbonates, hydroxides, chlorides, alkoxides, and the like of each metal (Li, La, Zr, Al, or Ga) can be used.

A preferable Li ion conductor obtained by the above-described method is an Li ion conductor that has a garnet-type composite metal oxide phase (L) containing Li, La, Zr, and O, and may have a diffraction peak at least one of at 2θ=13.8° and 15.2° in X-ray diffraction measurement using CuKα rays. In a crystal structure caused due to the diffraction peak at 2θ=13.8° or 2θ=15.2° , the atoms included in the crystal may be substituted with other atoms. In this case, as for each of the diffraction peaks, the angle at which the diffraction peak appears can shift in the range of ±1° . The Li ion conductor of one or more embodiments of the present invention also includes such a case, that is, is an Li ion conductor that has a garnet-type composite metal oxide phase (L) containing Li, La, Zr, and O, and has a diffraction peak at least one of at 2θ=13.8° ±1 and 2θ=15.2° and 20 =15.2° ±1° in X-ray diffraction measurement using CuKα rays. The range of 2θ=13.8° ±1° may be 2θ=13.8° ±0.5° , 13.8° ±0.3° , or 13.8° . The range of 2θ =15.2° ±1° may be 2θ=15.2° ±0.5° , 15.2° ±0.3° , or 15.2° .

The garnet-type composite metal oxide phase (L) containing Li, La, Zr, and O is a phase in which La³⁺occupies a position A, Zr⁴⁺occupies a position B, and Li⁺occupies a position C and an interstitial position in a crystal represented by a composition formula of A₃B₂C₃O₁₂, and can be usually represented by a composition formula of Li₇La₃Zr₂O₁₂. The phase (L) may be a cubic crystal. In addition, the garnet-type composite metal oxide phase (L) further may contain Al³⁺and/or Ga³⁺. In this case, a part of an Li⁺site in Li₇La₃Zr₂O₁₂ may be substituted with Al³+and/or Ga³+. Hereinafter, the garnet-type composite metal oxide containing Li, La, Zr, and O is sometimes referred to as “LLZ” including the case of being substituted with another element.

As described above, in the phase (L) in one or more embodiments of the present invention, a part of the Li⁺site in Li₇La₃Zr₂O₁₂ may be substituted with Al³⁺and/or Ga³+, but may be not substituted with an element other than Al and Ga.

Furthermore, the Li ion conductor of one or more embodiments of the present invention has a characteristic that a peak is observed at least one of at 2θ=13.8° ±1° and 15.2° ±1° in X-ray diffraction measurement using CuKα rays, and peaks may be observed at both positions of 2θ=13.8° ±1° and 15.2° ±1° .

Moreover, for the Li ion conductor of one or more embodiments of the present invention, a diffraction peak corresponding to 2θ=30.9° among the diffraction peaks of a cubic crystal Li_{6.25}Ga_{0.25}La₃Zr₂O₁₂ in X-ray diffraction measurement using CuKα rays may be observed at not less than 2θ=30.5 and not greater than 30.9° . When the LLZ is substituted with an element having an ionic radius smaller than the ionic radii of Li, La, Zr, and O, a diffraction peak corresponding to 2θ=30.9° tends to shift and appear on the higher angle side than 30.9° . On the other hand, when the LLZ is substituted with an element having an ionic radius larger than the ionic radii of Li, La, Zr, and O, a diffraction peak corresponding to 2θ=30.9° tends to shift and appear on the lower angle side than 30.9° . The diffraction peak corresponding to 2θ=30.9° may appear at not less than 2θ=30.5 and less than 30.9° . It is considered that, for example, when a part of the garnet-type composite metal oxide phase (L) containing Li, La, Zr, and O is substituted with Cl element, a diffraction peak corresponding to 2θ=30.9° appears at not less than 2θ=30.5° and less than 30.9° .

The Li ion conductor of one or more embodiments of the present invention may have a lattice constant of greater than 12.95 Å and not greater than 13.15 Å. It is considered that, for example, when a part of the garnet-type composite metal oxide phase (L) containing Li, La, Zr, and O is substituted with Cl element, the Li ion conductor has such a lattice constant.

As described above, the Li ion conductor of one or more embodiments of the present invention can be produced using a eutectic mixture of two metal halides in a preferable mode. In an example that is one preferable mode in which Li is contained as a metal, the obtained Li ion conductor has a metal-containing phase (K) different from the phase (L), and the phase (K) contains a halogen element and Li. In a further preferable mode, the phase (K) contains Li, Ta, and a halogen element.

The Li ion conductor of one or more embodiments of the present invention may have an aggregated structure of particles having the garnet-type composite metal oxide phase (L) and has the phase (K) at the particle interfaces. When the phase (K) exists at the particle interfaces of the phase (L), Li ions can be smoothly conducted from the phase (L) to the phase (L) through the phase (K).

The Li ion conductor of one or more embodiments of the present invention can have an activation energy Ea of 0.6 eV or less at room temperature by impedance measurement, and can have an Li ion conductivity σₜₒₜₐₗ of 1.0×10⁻⁷S/cm or greater at room temperature. The activation energy Ea may be 0.57 eV or less, 0.55 eV or less, or 0.50 eV or less. The lower limit of the activation energy Ea is not particularly limited, but is, for example, 0.25 eV. In addition, the Li ion conductivity σₜₒₜₐₗ may be 2.0×10⁻⁷ S/cm or greater, 4.0×10⁻⁷ S/cm or greater,.0×10⁻⁶ S/cm or greater, 5.0×10⁻⁶ S/cm or greater, or 1.0×10⁻⁵ S/cm or greater. The upper limit of the Li ion conductivity σₜₒₜₐₗ is not particularly limited, but is, for example, 7.0×10⁻⁵ S/cm.

The present application claims the benefit of the priority dates of Japanese patent application No. 2019-167381 filed on Sep. 13, 2019. All of the contents of the

Japanese patent application No. 2019-167381 filed on September 13, 2019 are incorporated by reference herein.

EXAMPLES

One or more embodiments of the present invention will be described in more detail below by means of examples. One or more embodiments of the present invention are not limited by the following examples, and can also be carried out with appropriate modifications being made within the scope of the gist described above and below, and any of these modifications are included in the technical scope of one or more embodiments of the present invention.

### Example 1

To 100 parts by mass of Li_{6.25}Ga_{0.25}La₃Zr₂O₁₂ manufactured by Toshima Manufacturing Co., Ltd., 50 parts by mass of a eutectic mixture of LiCl and TaCl₅ (mole ratio of LiCl and TaCl₅ is 50:50, melting point: 220° C.) was mixed using a mortar for 30 minutes. The obtained mixed powder was put into a mold, and a pressure of 375 MPa was applied thereto, to mold pellets having a diameter of 10 mm and a thickness of about 1 mm. The mixing using the mortar and the molding of the pellets were performed in a dry room. The dew point temperature in the dry room was —60° C. The molded pellets were annealed in a small electric furnace (under an argon atmosphere) in a glove box (dew point temperature: —90° C.) at 220° C. for 15 minutes, and Au was sputtered on both sides of the pellets to form electrodes having a diameter of 8 mm. The obtained pellet sample was set in an all-solid-state battery evaluation cell manufactured by Hohsen Corp., and was connected to a potentio-galvanostat, impedance measurement was performed in the temperature range of room temperature to 100° C., and evaluation of Li ion conductivity was made. As a result, the ion conductivity σₜₒₜₐₗ at room temperature was 2.2×10⁻⁵ S/cm. In addition, an activation energy was calculated from an Arrhenius plot using the ion conductivity value at each temperature. As a result, the activation energy Ea was 0.39 eV.

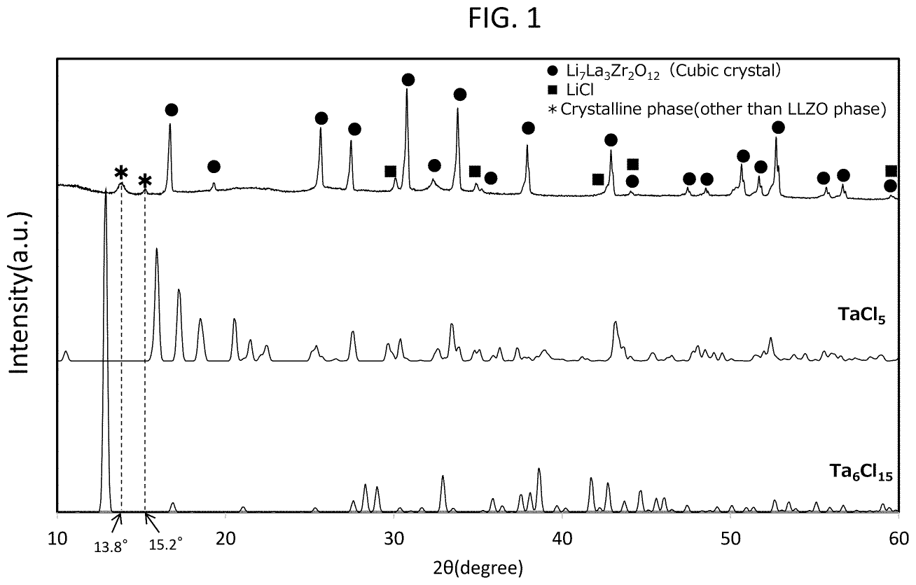

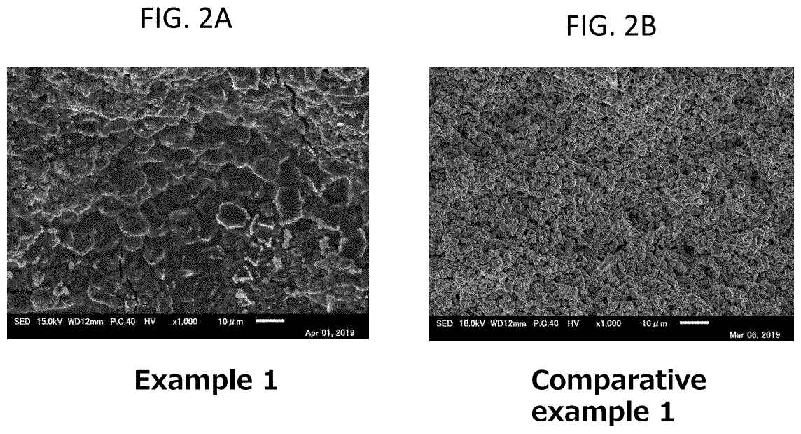

FIG. 1 shows the results obtained by analyzing the crystal structure of a powder sample obtained by crushing the annealed pellets, using an XRD (X-ray Diffraction analysis) device manufactured by Bruker. The XRD measurement was performed with CuKa rays, λ=1.5418 nm, and θ=10 to 50° . From FIG. 1, a peak corresponding to Li₇La₃Zr₂O₁₂ having a cubic crystal is observed, and a peak corresponding to the added LiCl is observed. In addition, a crystalline phase different from Li₇La₃Zr₂O₁₂, LiCl, and TaCl₅ was observed at positions of 2θ=13.8° and 15.2° .

### Examples 2 to 10

Pellets were molded and annealed and the ion conductivity and the activation energy at room temperature were measured in the same manner as in Example 1, except that the type and amount of the eutectic mixture to be mixed with Li_{6.25}Ga_{0.25}La₃Zr₂O₁₂ and the annealing conditions were as described in Table 1. The results are shown in Table 1. For only Example 4, the measurement results at 50° C. are shown.

### Comparative Example 1

The ion conductivity at room temperature was measured in the same manner as in Example 1, except that only Li_{6.25}Ga_{0.25}La₃Zr₂O₁₂ was molded and annealed without using the eutectic mixture of LiCl and TaCl₅. The results are shown in Table 1.

### Reference example 1

Li_{6.25}Ga_{0.25}La₃Zr₂O₁₂ manufactured by Toshima Manufacturing Co., Ltd., which is the same as that used in Example 1, was put into a mold, and a pressure of 375 MPa was applied thereto, to mold pellets having a diameter of 10 mm and a thickness of about 1 mm. The molded pellets were annealed in the atmosphere at 1230° C. for 1200 minutes, and Au was sputtered on both sides of the pellets to form electrodes having a diameter of 8 mm. Then, the Li ion conductivity at room temperature was measured in the same manner as in Example 1. The results are shown in Table 1.

TABLE 1

| | | | | | Added amount of | | | | Ion conductivity | |
|---|---|---|---|---|---|---|---|---|---|---|
| | | | | | eutectic mixture | | | | Ion conductivity | |
| | | Eutectic mixture | | | with respect to | Annealing conditions | | | at room | |
| | | | | Melting | 100 parts by | Temper- | | | temperature | |
| Example | | | | point | mass of LLZ | ature | Time | Atmo- | σₜₒₜₐₗ | Ea |
| No. | Composition of LLZ | Composition | | (° C.) | (parts by mass) | (° C.) | [min] | sphere | [S/cm] | [eV] |
| Example 1 | Li_{6.25}Ga_{0.25}La₃Zr₂O₁₂ | LiCl | TaCl₅ | 220 | 50 | 220 | 15 | Ar | 2.2 × 10⁻⁵ | 0.39 |
| | | 50 mol % | 50 mol % | | | | | | | |
| Example 2 | Li_{6.25}Ga_{0.25}La₃Zr₂O₁₂ | LiCl | TaCl₅ | 220 | 30 | 220 | 15 | Ar | 4.1 × 10⁻⁷ | 0.53 |
| | | 50 mol % | 50 mol % | | | | | | | |
| Example 3 | Li_{6.25}Ga_{0.25}La₃Zr₂O₁₂ | LiCl | LiF | 498 | 50 | 500 | 360 | Ar | 4.5 × 10⁻⁷ | 0.59 |
| | | 71 mol % | 29 mol % | | | | | | | |
| Example 4 | Li_{6.25}Ga_{0.25}La₃Zr₂O₁₂ | LiCl | LiF | 498 | 30 | 500 | 360 | Ar | 4.6 × 10⁻⁷ | 0.57 |
| | | 71 mol % | 29 mol % | | | | | | | |
| Example 5 | Li_{6.25}Ga_{0.25}La₃Zr₂O₁₂ | LiCl | LiF | 498 | 20 | 500 | 360 | Ar | 2.7 × 10⁻⁷ | 0.58 |
| | | 71 mol % | 29 mol % | | | | | | | |
| Example 6 | Li_{6.25}Ga_{0.25}La₃Zr₂O₁₂ | LiCl | ZrCl₄ | 590 | 30 | 600 | 360 | Ar | 7.2 × 10⁻⁸ | 0.59 |
| | | 67 mol % | 33 mol % | | | | | | (50° C.) | |
| Example 7 | Li_{6.25}Ga_{0.25}La₃Zr₂O₁₂ | LiCl | AlCl₃ | 143 | 50 | 220 | 15 | Ar | 1.2 × 10⁻⁸ | 0.47 |
| | | 56 mol % | 44 mol % | | | | | | | |
| Example 8 | Li_{6.25}Ga_{0.25}La₃Zr₂O₁₂ | LiCl | AlCl₃ | 143 | 40 | 220 | 15 | Ar | 5.0 × 10⁻⁸ | 0.43 |
| | | 56 mol % | 44 mol % | | | | | | | |
| Example 9 | Li_{6.25}Ga_{0.25}La₃Zr₂O₁₂ | LiCl | NbCl₅ | 220 | 50 | 220 | 15 | Ar | 1.1 × 10⁻⁸ | 0.47 |
| | | 50 mol % | 50 mol % | | | | | | | |
| Example 10 | Li_{6.25}Ga_{0.25}La₃Zr₂O₁₂ | LiF | TaF₅ | 96° C. | 50 | 300 | 15 | Ar | 1.9 × 10⁻⁷ | 0.52 |
| | | 50 mol % | 50 mol % | or lower | | | | | | |

| | | | | | | | | |
|---|---|---|---|---|---|---|---|---|
| Comparative | Li_{6.25}Ga_{0.25}La₃Zr₂O₁₂ | absent | — | 220 | 15 | Ar | OVR | — |
| example 1 | | | | | | | | |
| Reference | Li_{6.25}Ga_{0.25}La₃Zr₂O₁₂ | absent | — | 1230 | 1200 | air | 5.2 × 10⁻⁴ | |
| example 1 | | | | | | | | |

The ion conductor of Example 1 obtained by molding a mixture of the LLZ and the eutectic mixture having a eutectic point of 600° C. or lower and heat-treating the obtained molded product at 600° C. or lower exhibited good ion conductivity as shown in Table 1. Also, Examples 2 to 10 in each of which an ion conductor was produced in the same method as in Example 1 exhibited good ion conductivity as shown in Table 1. On the other hand, in Comparative Example 1 in which the molded body of only the LLZ was annealed under the same conditions as in Example 1, no ion conduction occurred at room temperature.

FIG. 2A shows an SEM observation image of the ion conductor of Example 1, and FIG. 2B shows an SEM observation image of the ion conductor of Comparative Example 1. As shown in FIG. 2B of Comparative Example 1 in which a eutectic mixture was not used, an aggregated structure of particles of the LLZ is observed, and the interfaces between the particles are not connected. On the other hand, when FIG. 2A showing Example 1 is compared with FIG. 2B, a particle structure of the LLZ is observed in FIG. 2A, but a phase connecting the particle interfaces of the LLZ is observed. Considering; the fact that a peak of LiCl is observed in XRD of FIG. 1; the annealing temperature in Example 1; and the melting point of the eutectic mixture used in Example 1, the phase connecting the particle structure of the LLZ is considered to be a phase obtained as a result of the eutectic mixture of LiCl and TaCl₅ being melted.

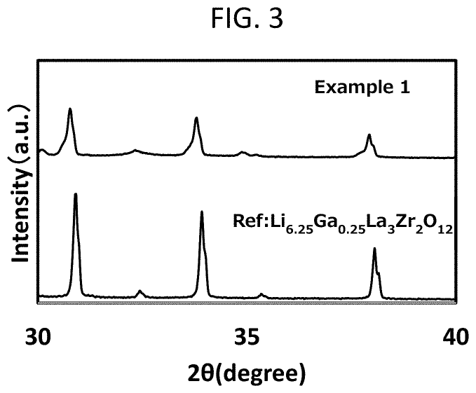

Furthermore, FIG. 3 shows an enlarged view, around 2θ=30 to 40° , of the XRD analysis results of Example 1 shown in FIG. 1, together with an XRD diffraction chart of

Li_{6.25}Ga_{0.25}La₃Zr₂O₁₂. As shown in FIG. 3, in the ion conductor of Example 1, a diffraction peak corresponding to 20 =30.9° shifted to the lower angle side was observed at a position of not less than 2θ=30.5° and less than 30.9° .

For Examples 1 and 2, when d value that was an interplanar spacing was obtained by the following equations (1) and (2) using the diffraction peak of the (400) plane obtained in the above-described XRD measurement and a lattice constant was calculated, the lattice constant was 12.99 Å in Example 1 and 13.00 Å in Example 2.

2dsinθ=nÅ (1) 1/d²=(h²+k²+l²)/a² (2)

d: interplanar spacing, a: lattice constant, h, k, and l: Miller index

The Li ion conductor of one or more embodiments of the present invention can be suitably used as a solid electrolyte material for a secondary battery.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

What is claimed is:

1. An Li ion conductor comprising a garnet-type composite metal oxide phase (L) containing Li, La, Zr, and 0, wherein
the Li ion conductor has a diffraction peak at least one of at 2θ=13.8° ±1° and at 2θ=15.2° ±1° in X-ray diffraction measurement with CuKα rays.

2. The Li ion conductor according to claim 1, wherein the Li ion conductor has a metal-containing phase (K) different from the garnet-type composite metal oxide phase (L), and the metal-containing phase (K) contains a halogen element and Li.

3. The Li ion conductor according to claim 1, wherein a diffraction peak corresponding to 2θ=30.9° among diffraction peaks of a cubic crystal Li_{6.25}Ga_{0.25}La₃Zr₂O₁₂ in the X-ray diffraction measurement with CuKα rays is observed at not less than 2θ=13.5° and not greater than 30.9° .

4. The Li ion conductor according to claim 1, wherein the Li ion conductor has a lattice constant of greater than 12.95 Å and not greater than 13.15 Å.

5. The Li ion conductor according to claim 1, wherein the Li ion conductor has an activation energy Ea of 0.6 eV or less by impedance measurement.

6. The Li ion conductor according to claim 1, wherein the Li ion conductor has an Li ion conductivity σₜₒₜₐₗ of 1.0×10⁻⁷ S/cm or greater at room temperature by impedance measurement.

7. A method for producing an Li ion conductor comprising a garnet-type composite metal oxide phase (L) containing Li, La, Zr, and O, the method comprising connecting interfaces of the garnet-type composite metal oxide phase (L) with a eutectic mixture having a melting point of 600° C. or lower.

8. The method according to claim 7, wherein the interfaces of the garnet-type composite metal oxide phase (L) are connected by molding a mixture of the eutectic mixture having the melting point of 600° C. or lower and a garnet-type composite metal oxide containing Li, La, Zr, and O, and heat-treating an obtained molded product at 600° C. or lower.

9. The method according to claim 7, wherein the eutectic mixture is a eutectic mixture of two metal halides.

10. The method according to claim 7, wherein the eutectic mixture is a eutectic mixture of LiF, ZrCl₄, AlCl₃, NbCl₅, or TaCl₅ with LiCl or a eutectic mixture of LiF with TaF₅.

11. The Li ion conductor according to claim 2, wherein a diffraction peak corresponding to 2θ=30.9° among diffraction peaks of a cubic crystal Li_{6.25}Ga_{0.25}La₃Zr₂O₁₂ in the X-ray diffraction measurement with CuKα rays is observed at not less than 2θ=30.5° and not greater than 30.9° .

12. The Li ion conductor according to claim 11, wherein the Li ion conductor has a lattice constant of greater than 12.95 Å and not greater than 13.15 Å.
